(19) United States
(12) Patent Application Publication
(10) Pub. No.: US 2007/0298925 A1
(43) Pub. Date: Dec. 27, 2007

(54) FLUID PASSAGE STRUCTURE

(75) Inventors: Tetsurou KITAHARA, Shizuoka (JP); Kohei Tsuchiya, Shizuoka (JP)

Correspondence Address: FOLEY AND LARDNER LLP;SUITE 500, 3000 K STREET NW, WASHINGTON, DC, 20007, US

(73) Assignee: JATCO Ltd

(21) Appl. No.: 11/756,806

(22) Filed: Jun. 1, 2007

(30) Foreign Application Priority Data
Jun. 23, 2006 (JP) 2006-173293

(51) Int. Cl. F16H 57/04

(52) U.S. Cl. 475/159

(57) ABSTRACT

A fluid passage structure includes a piston defining a piston chamber, a return spring to urge the piston in a direction decreasing a volume of the piston chamber, and a casing. The casing is formed with a fluid supply passage to supply a fluid pressure into the piston chamber. The supply passage includes an open end opening in the piston chamber and confronting the piston. The open end of the supply passage has an area so determined as to prevent the return spring from being deformed by kinetic energy of an operating fluid gushing into the piston chamber.

### BACKGROUND OF THE INVENTION

The present invention relates to apparatus or structure for supplying a fluid to a hydraulic chamber.

A U.S. Pat. No. 5,013,287 to Hayakawa et al. (corresponding to JP H02(1990)-042240 A) shows an automatic transmission as shown in FIG. 4. The automatic transmission of FIG. 4 includes a torque converter 110, a transmission mechanism 120 and an oil pump 100 disposed axially between torque converter 110 and transmission mechanism 120, for producing an oil pressure used in the transmission. Oil pump 100 includes a pump main body 101 arranged to receive a driving force of an engine through torque converter 110 and to produce an oil pressure by using the driving force of the engine, and a pump cover 102 covering pump main body 101 from the transmission's side. On the transmission's side of pump cover 102, there is provided a piston 103 for pushing a friction element 121 of transmission mechanism 120.

Between piston 103 and pump cover 102, there is formed a piston chamber or hydraulic pressure chamber 104, and pump cover 102 is formed with an oil passage 105 for conveying an oil pressure produced by pump main body 101, and an oil hole 106 having a circular cross sectional shape and connecting the oil passage 105 to piston chamber 104. Piston 103 is slidable in an axial direction (left and right direction as viewed in FIG. 4). When the oil pressure is supplied from oil passage 105, into piston chamber 104 through oil hole 106, the piston 103 moves toward friction element 121, and thereby presses friction element 121.

### SUMMARY OF THE INVENTION

However, the oil hole 106 shown in FIG. 4 is reduced in size, so that the oil pressure is applied only to a relatively narrow spot in the pressure receiving surface of piston 103. When the oil pressure is supplied through oil hole 106 into piston chamber 104, especially immediately after a start of movement of piston 103 (immediately after a start of supply of the oil pressure through oil hole 106 into piston chamber 104 in the state in which the fluid pressure is null or minimum in piston chamber 104), the oil pressure is applied only to the relatively narrow spot confronting the oil hole 106. A fluid passage structure having oil holes distributed over a relatively wide area may be able to prevent localized application of fluid pressure or asymmetric load. However, such a fluid passage structure requires a complicated arrangement of fluid passages, and tends to cause interference with other fluid passages.

Accordingly, the piston tends to receive a localized load, and to slide in an inclined state in which the piston is inclined with respect to a straight line perpendicular to the sliding direction of the piston. Therefore, this structure tends to cause undesired stick-slip movement of the piston.

Therefore, it is an object of the present invention to provide a fluid passage structure for causing a piston to slide in a correct posture.

According to one aspect of the present invention, a fluid passage structure comprises: a piston defining a piston chamber; a return spring to urge the piston in a direction decreasing a volume of the piston chamber; and a casing formed with a fluid supply passage to supply a fluid pressure into the piston chamber, the supply passage including an open end opening in the piston chamber and confronting the piston, the open end of the supply passage having an area so determined as to prevent the return spring from being deformed by kinetic energy of an operating fluid gushing into the piston chamber.

According to another aspect of the present invention, an apparatus comprises: a piston defining a piston chamber; a return spring to urge the piston in a direction decreasing a volume of the piston chamber; and a casing formed with a fluid supply passage to supply a fluid pressure into the piston chamber, the supply passage including an open end opening in the piston chamber and confronting the piston, the open end of the supply passage having an area so determined as to hold kinetic energy of an operating fluid gushing into the piston chamber smaller than or equal to elastic energy of the return spring.

### BRIEF DESCRIPTION OF THE DRAWINGS

FIG. 1 is a sectional view of an automatic transmission provided with a fluid passage structure according to one embodiment of the present invention.

FIG. 2 is an enlarged sectional view showing fluid passages formed in a pump cover of the automatic transmission of FIG. 1.

FIG. 3 is a view of the pump cover as viewed from a transmission mechanism's side.

FIG. 4 is an enlarged sectional view showing a fluid passage structure around an oil pump in an automatic transmission of earlier technology.

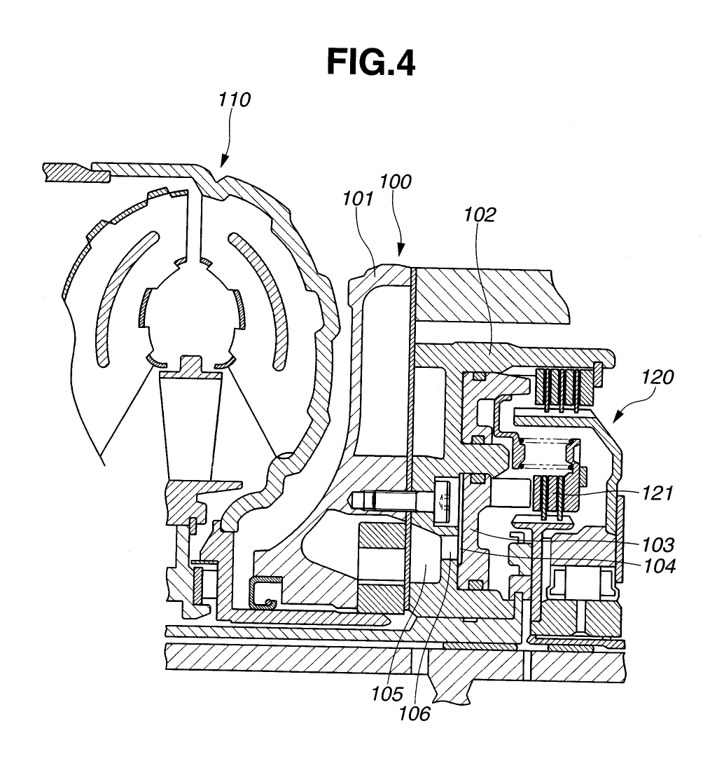

### DETAILED DESCRIPTION OF THE INVENTION

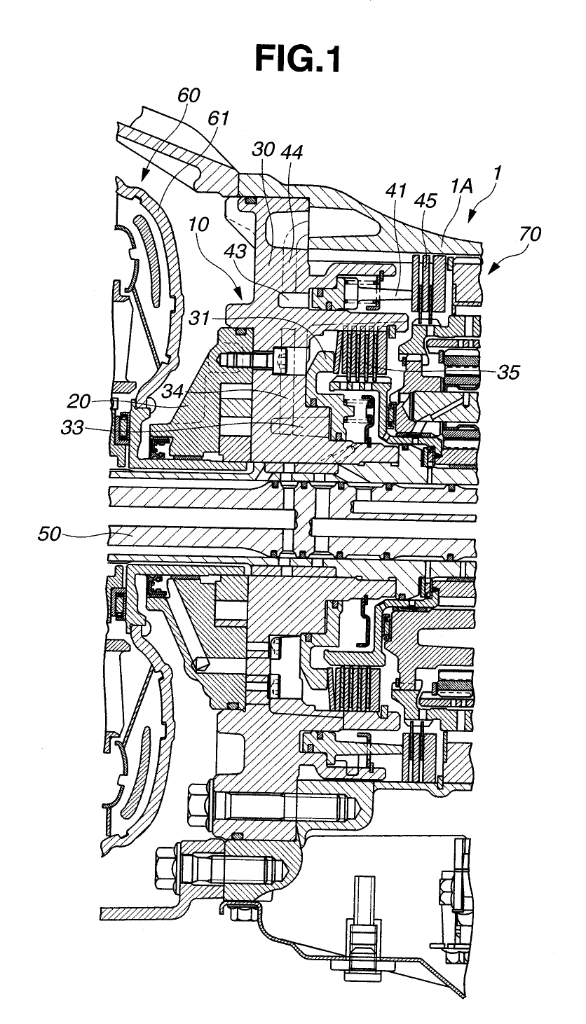

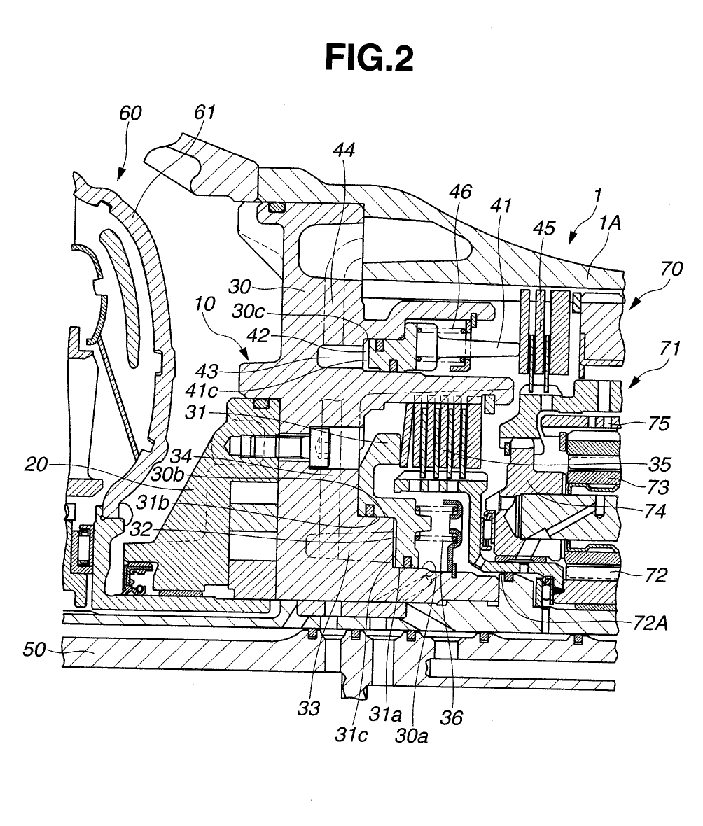

FIG. 1 shows, in section, a part of an automatic transmission 1 having a fluid passage structure according to one embodiment of the present invention, formed in the vicinity of an oil pump; and FIG. 2 shows, in enlarged section, fluid passages formed in a casing including a pump cover.

Automatic transmission 1 shown in FIG. 1 includes a torque converter 60 and a transmission mechanism 70 which are mounted on a center shaft 50. Torque converter 60 is adapted to be connected with an engine, and to receive driving power from the engine. Transmission mechanism 70 is arranged to receive input rotation from torque converter 60 and to deliver output rotation of a desired speed, toward drive wheels of a vehicle. Automatic transmission 1 further includes an oil pump 10 disposed axially between torque converter 60 and transmission mechanism 70, and arranged to produce a fluid pressure used in automatic transmission 1. The driving torque supplied from the engine is controlled or multiplied by torque converter 60 and transmitted to center shaft 50. Moreover, the driving torque of the engine is inputted, through a housing 61 of torque converter 60, into oil pump 10.

Oil pump 10 includes a pump body 20 located on the torque converter's side (left side as viewed in FIG. 1); and a pump cover 30 covering pump body 20 on the transmission's side (right side). Pump cover 30 is fixed to a transmission case 1A of automatic transmission 1. Pump body 20 produces a fluid or oil pressure by using the driving force of the engine inputted through housing 61 of torque converter 60. The oil pressure produced by oil pump 10 is supplied, through pump cover 30, to a control valve unit (not shown) including one or more valves. The control valve unit supplies the oil pressure to a piston chamber or piston chambers of one or more of engaging devices such as clutches and brakes in transmission mechanism 70 by changing the conditions of the valves, and thereby achieves a desired shift speed of the transmission mechanism 70 by engaging one or more of the engaging devices.

Transmission mechanism 70 includes at least a planetary gear set 71 adjacent to oil pump 10 as shown in FIG. 2. Planetary gear set 71 includes a sun gear 72 located at the center position, a ring gear 75 having internal teeth, and a planet carrier 74 supporting rotation shafts of pinion gears 73 arranged around sun gear 72 and engaged with sun gear 72 and ring gear 75.

A first brake 35 is disposed between sun gear 72 and pump cover 30. Sun gear 72 includes an extension portion 72A extending toward pump cover 30 (leftward in FIG. 2), and first brake 35 can engage the extension portion 72A of sun gear 72 with pump cover 30 fixed to transmission case 1A. When first brake 35 is engaged, the sun gear 72 is held stationary to transmission case 1A. A second brake 45 is disposed between carrier 74 and transmission case 1A, and arranged to hold carrier 74 stationary to transmission case 1A.

First and second pistons 31 and 41 are disposed axially between pump cover 30 and planetary gear set 71. First and second pistons 31 and 41 are annular members arranged coaxially. First piston 31 is surrounded by second piston 41. Pump cover 30 includes a first tubular portion projecting axially toward planetary gear set 71 and having a first outside circumferential (or cylindrical) surface 30a, and a second outside circumferential (or cylindrical) surface 30b having a diameter larger than the diameter of the first outside circumferential surface 30a. First piston 31 has a stepped cross sectional shape, and includes a radial inner portion and a radial outer portion set back axially from the radial inner portion toward pump cover 30. The radial inner portion of first piston 31 includes a first inside circumferential (cylindrical) surface 31a and the radial outer portion includes a second inside circumferential (cylindrical) surface 31b which has a diameter larger than the diameter of first inside circumferential surface 31a.

First piston 31 is slidably mounted on the first tubular portion of pump cover 30. First inside circumferential surface 31a of first piston 31 fits over the first outside circumferential surface 30a of pump cover 30 slidably in the axial direction along center shaft 50. Similarly, second inside circumferential surface 31b of first piston 31 fits over the second outside circumferential surface 30b of pump cover 30 slidably in the axial direction. Thus, a first piston chamber 32 having a variable volume is formed between pump cover 30 and first piston 31. In this example, first piston chamber 32 is formed axially between pump cover 30 and first piston 31, and radially between the first outside circumferential surface 30a and the second inside circumferential surface 31b.

A first fluid hole 33 (serving as an open end of a fluid supply passage) is opened in an annular surface which extends radially between the first and second outside circumferential surfaces 30a and 30b of pump cover 30. A first fluid passage 34 (serving as the fluid supply passage) connects the first fluid hole 33 with the control valve unit, and conveys a fluid pressure from the control valve unit to first fluid hole 33. The oil pressure supplied from the control valve unit through first fluid passage 34 can gush through first fluid hole 33, into the first piston chamber 32. First fluid passage 34 extends from an inner end connected with the first fluid hole 33, radially outwards in the pump cover 30, to an outer end near the outer circumference of pump cover 30. The oil pressure from the control valve unit is supplied from the outer end of first fluid passage 34 into the first fluid passage 34 toward the first fluid hole 33.

First piston 31 includes a first annular surface 31c serving as a pressure receiving surface for receiving the fluid pressure supplied into first piston chamber 32 from first fluid hole 33. First annular surface or pressure receiving surface 31c extends radially between the first and second inside circumferential surfaces 31a and 31b of first piston 31. The pressure receiving surface 31c of first piston 31 faces axially toward pump cover 30 (in the leftward direction as viewed in FIG. 2). In this example, the first annular surface 31c of first piston 31 is a flat radial surface to which the axis of piston 31 (or the center axis of center shaft 50) is perpendicular; the annular surface of pump cover 30 in which first fluid hole 33 is opened is also a flat radial surface to which the axis of pump cover 30 (or the center axis of center shaft 50) is perpendicular; and both annular surfaces of first piston 31 and pump cover 30 confront axially each other and define the first piston chamber 32 axially therebetween. When a fluid pressure is supplied into first piston chamber 32, the first piston 31 moves rightwards as viewed in FIG. 1 (against the resilient force of a return spring 36), and presses a brake (or friction) plate pack of first brake 35 with a radial outer pushing portion. As a result, first brake 35 is engaged, and sun gear 72 is held stationary to a stationary casing made up of at least pump cover 30 and transmission case 1A. The pushing portion of first piston 31 for engaging first brake 35 is located axially between pump cover 30 and the brake plate pack of first brake 35, on the radial outer side of the second inside circumferential surface 31b of first piston so that the radial inner and outer portions of first piston 31 are surrounded by the pushing portion.

A first return spring 36 is arranged to urge the first piston 31 in an axial direction to decrease the volume of first piston chamber 32 (leftwards as viewed in FIG. 2), and thereby to hold the first brake 35 disengaged securely when no fluid pressure is supplied to first piston chamber 32.

Second piston 41 is slidably fit in an annular recess 30c formed in pump cover 30. Therefore, a second piston chamber 42 of a variable volume is formed between second piston 41 and pump cover 30 (or the bottom of recess 30c). In addition to the before-mentioned first tubular portion having the first and second outside circumferential surfaces 30a and 30b, the pump cover 30 includes a second tubular portion and a third tubular portion projecting axially toward planetary gear set 71. The annular recess 30c is formed radially between the second and third tubular portions. The second tubular portion surrounds the first tubular portion, and the third tubular portion surrounds the second tubular portion. The brake plate pack of first brake 35 is disposed between the second tubular portion of pump cover 30, and the extension portion 72A of sun gear 72.

A second fluid hole 43 is opened in the annular bottom surface of annular recess 30c. A second fluid passage 44 connects the second fluid hole 43 with the control valve unit, and conveys a fluid pressure from the control valve unit to second fluid hole 43. The oil pressure supplied from the control valve unit through second fluid passage 44 can gush through second fluid hole 43, into the second piston chamber 42. Second fluid passage 44 extends from an inner end connected with the second fluid hole 43, radially outwards in the pump cover 30, to an outer end near the outer circumference of pump cover 30. The oil pressure from the control valve unit is supplied from the outer end of second fluid passage 44 into the second fluid passage 44 toward second fluid hole 43.

Second piston 41 includes a second annular (end) surface 41c serving as a pressure receiving surface for receiving the fluid pressure supplied into second piston chamber 42 from second fluid hole 43. The pressure receiving surface 41c of second piston 41 faces axially toward pump cover 30 (in the leftward direction as viewed in FIG. 2). In this example, the second annular surface 41c of second piston 41 is a flat radial surface to which the axis of piston 41 is perpendicular; the annular bottom surface of recess 30c in which second fluid hole 43 is opened is also a flat radial surface to which the axis of pump cover 30 is perpendicular; and both annular surfaces of second piston 41 and pump cover 30 confront axially each other and define the second piston chamber 42 axially therebetween. When a fluid pressure is supplied into second piston chamber 42, the second piston 41 moves rightwards as viewed in FIG. 2, and presses a brake plate pack of second brake 45 with a pushing end portion projecting toward the transmission's side (in the rightward direction in FIG. 2). As a result, second brake 45 is engaged, and the planet carrier 74 is held stationary to transmission case 1A. Second piston 41 is located axially between the brake plate pack of second brake 45 and pump cover 30.

A second return spring 46 is arranged to urge the second piston 41 in the (leftward) direction to decrease the volume of second piston chamber 42, and thereby to hold the second brake 45 disengaged securely when no fluid pressure is supplied to second piston chamber 42.

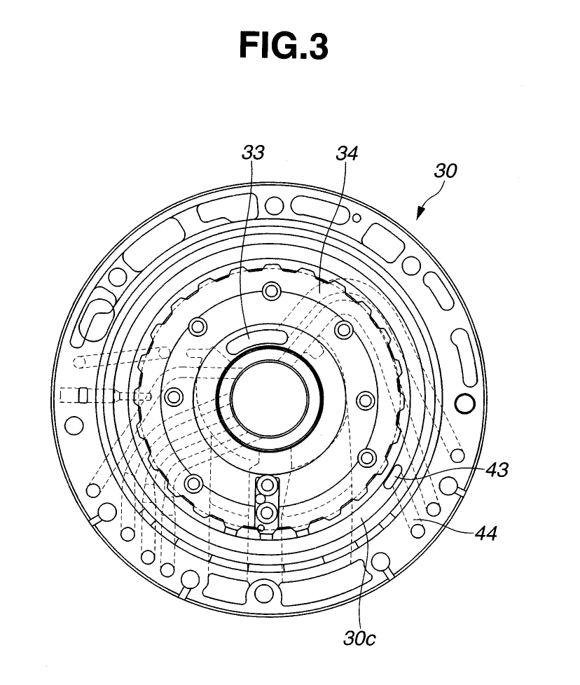

FIG. 3 shows pump cover 30 as viewed from the transmission's side (the right side in FIG. 2). First fluid hole 33 opening into first piston chamber 32 is an elongated hole elongated circumferentially in the form of a circular arc around the center axis of pump cover 30. From first fluid hole 33, the first fluid passage 34 extends radially outwards to the outer end near the outer circumference of pump cover 30. Similarly, second fluid hole 43 opening into second piston chamber 42 is an elongated hole elongated circumferentially in the form of a circular arc around the center axis of pump cover 30. From second fluid hole 43, the second fluid passage 44 extends radially outwards to the outer end near the outer circumference of pump cover 30. The oil flowing through first or second fluid passage 34 or 44 once expands in the elongated fluid hole 33 or 43, and then flows into the piston chamber 32 or 42.

The elongated shape of each of the fluid holes 33 and 43 for the corresponding piston chamber 32 or 42 is effective for preventing concentration of strong fluid pressure at a localized narrow spot, located away from the center axis, in the pressure receiving surface 31c or 41c and thereby for preventing the piston 31 or 41 from being inclined. The shapes and sizes of first and second fluid holes 33 and 43 are determined in the following manner.

First, the cross sectional area of first fluid hole 33 is determined in the following manner. First piston 31 is pressed against pump cover 30 by first return spring 36 when first piston chamber 32 receives no supply of the fluid pressure (and the fluid pressure in first piston chamber 32 is equal to a minimum setting). The first return spring 36 of this example is a set of smaller springs arranged (symmetrically around center shaft 50) to push first piston 31 toward pump cover 30 so as to prevent first piston 31 from being inclined with respect to the axis of the center shaft 50, or with respect to a perpendicular to the axis of the center shaft 50 (or to an imaginary flat plane to which the axis of center shaft 50 is perpendicular), and thereby maintain the balance of first piston 31. Hereinafter, the piston 31 is said to deviate from the correct posture when the piston 31 is inclined with respect to the axis of shaft 50 or with respect to a straight line perpendicular to the axis of shaft 50. When the kinetic energy of the fluid gushing into first piston chamber 32 is lower than the elastic energy of first return spring 36, then the fluid can be supplied into first piston chamber 32 without inclining first piston 31 without causing first piston 31 from deviating from the correct posture.

A relation between the elastic energy of first return spring 36 and the kinetic energy of the fluid is expressed by the following mathematical expression.

### [Mathematical Expression 1]

$$\frac{1}{2} {kx}^{2} \geq \frac{1}{2} {mv}^{2} \qquad ( 1 )$$

In the expression (1), the left side represents the elastic energy of first return spring 36; the right side represents the kinetic energy of the fluid; k is a spring constant (N/mm) of first return spring; x is a displacement (mm) of first return spring 36 from a free length of first return spring 36 in a set state; m is the mass (kg) of the inflowing fluid (oil); and v is a flow speed (mm/sec) of the inflowing fluid. In the following explanation, K is the elastic energy of first return spring 36, represented by the left side of the expression (1).

The mass of the fluid (oil) is given by the following expression (2) by using the flow rate and density.

### [Mathematical Expression 2]

m=Q·t·δ (2)

### In this expression, Q is the flow rate (mm³/sec) of the fluid flowing into first piston chamber 31; t is a time (sec) during which the fluid flows into first piston chamber 31, and δ is the density (kg/mm³) of the fluid (oil).

From the flow rate Q and a circuit cross sectional area (that is the cross sectional area of first fluid hole 33), the flow speed v of the fluid is expressed by the following mathematical expression (3)

### [Mathematical Expression 3]

$$v = \frac{Q}{A} \qquad ( 3 )$$

### In this equation, A is the circuit cross sectional area (mm²). As the circuit cross section area A becomes greater, then the flow speed v becomes lower, and the kinetic energy becomes smaller.

Substitution of expressions (2) and (3) into expression (1) provides the following mathematical expression (4).

### [Mathematical Expression 4]

$$K \geq \frac{1}{2} {Q}^{3} \cdot t \cdot δ \cdot \frac{1}{{A}^{2}} \qquad ( 4 )$$

### The elastic energy of first return spring 36 is related with the cross sectional area A, as expressed by the following expression (5).

### [Mathematical Expression 5]

$$A \geq \sqrt{\frac{{Q}^{3} \cdot t \cdot δ}{2 K}} \qquad ( 5 )$$

### Thus, it is possible to maintain the correct balanced posture of first piston 31 when the circuit cross sectional area A is so set as to satisfy the condition expressed by expression (5) with respect to the elastic energy K of first return spring 36.

In this embodiment, the cross section area A of first fluid hole 33 is limited between an upper limit and a lower limit.

The lower limit is determined in the following manner. By using the expression (5), it is possible to determine a minimum cross sectional area satisfying the condition of the elastic energy of first return spring 36 being greater than or equal to the kinetic energy of the oil. If, as an example, the spring constant k of first return spring 36 is 7.5 N/mm, the displacement x of first return spring 36 from the free length in the set state is 4.3 mm, and the first return spring 36 is composed of 16 springs; then the elastic energy K of first return spring 36 is given from the left side of expression (1):

K=(½)×7.5×(4.3)²×16=1109.4 Nmm

Furthermore, assuming that the flow rate Q of the fluid is 2000 mm³/sec, the fluid has flowed into first piston chamber 32 for one second (t=1 sec), and the density δ of the fluid (oil) is 0.865×10⁻⁶ kg/mm³, substitution of these values into expression (5) provides:

A≧55.8 mm²

When the conditions of first return spring 36, the flow rate of the oil and other conditions are as in the example mentioned above, the first fluid hole 33 having the cross sectional area A set equal to or greater than 55.8 mm² can prevent the kinetic energy of the oil from becoming greater than the elastic energy of first return spring 36, and thereby prevent the first piston 31 from being inclined by the oil flowing toward the pressure receiving surface 31c of first piston 31.

The upper limit of the cross sectional area of first fluid hole 33 is determined in the following manner. Assuming that the idle speed of the engine is 500 rpm, the discharge flow quantity (or inherent discharge flow quantity) of oil pump 10 is 15.5 cc/rev, and all the oil discharged from oil pump 10 in the idling operation of the engine is supplied into first piston chamber 32, then the quantity Q of the fluid flowing into first piston chamber 32 is:

$$\begin{matrix}Q = 15.5 {cm}^{3} \text{/} rev \times 500 rpm \\ = 7750 {cm}^{3} \text{/} min \\ = 129166.7 {mm}^{3} \text{/} sec\end{matrix}$$

Assuming that the fluid flows into first piston chamber 32 for one second (t=1 sec), and the density b of the fluid (oil) is 0.865×10⁻⁶ kg/mm³, substitution of these values into expression (5) together with the calculated flow rate Q of 129166.7 mm³/sec provides:

A=916.6 mm² (≈917 mm²)

When all the oil discharged from oil pump 10 in the idling operation of the engine is supplied to first piston chamber 32, the first fluid hole 33 having the cross sectional area A set equal to 916.6 mm² can prevent the first piston 31 from being inclined by the oil flowing toward the pressure receiving surface 31c of first piston 31. Thus, the upper limit of the cross sectional area A of first fluid hole 33 is 916.6 mm² in this example.

Thus, the lower limit is 55 mm² and the upper limit is 917 mm² in this example omitting the fractional part after the decimal point (55 mm²≦A≦917 mm²). The fluid hole 33 having the cross sectional area A which is equal to or greater than 55 mm² and which is equal to smaller than 917 mm² (55 mm²≦A≦917 mm²) can prevent the first piston 31 from being inclined by the fluid flowing toward the pressure receiving surface 31c.

Like the first fluid hole 33, the second fluid hole 43 is set between the lower limit of 55 mm² and the upper limit of 917 mm². The second fluid hole 43 having the cross sectional opening area which is equal to or greater than 55 mm² and which is equal to smaller than 917 mm² (55 mm²≦A≦917 mm²) can prevent the second piston 41 from being inclined by the fluid flowing toward the pressure receiving surface 41c.

In the thus-constructed structure according to the embodiment, the first and second fluid holes 33 and 34 are elongated and so sized as to prevent the kinetic energy of operating fluid supplied into the piston chamber 32 or 42 from exceeding the elastic energy of the return spring 36 or 46. Therefore, the structure can prevent localized impingement of the fluid pressure against a narrow off-center spot of the annular pressure receiving area 31c or 41c of the piston 31 or 41, and keep the piston 31 or 41 always in a balanced position without being inclined with respect to the center axis and a radial plane to which the center axis is perpendicular. In the example mentioned above, it is preferable to set the opening size of at least one of the first and second fluid holes 33 and 43 greater than or equal to 55 mm², and smaller than or equal to 917 mm² (55 mm²≦A≦917 mm²).

The flow rate Q in mathematical expression (5) is the quantity determined by an idling speed of the engine and an inherent discharge quantity of the fluid pump 10 driven by the engine, and the time t is a time from an empty state in which the volume of the piston chamber is minimum and substantially empty, to a full state in which the volume of the piston chamber is minimum and substantially filled with the operating fluid.

This application is based on a prior Japanese Patent Application No. 2006-173293 filed on Jun. 23, 2006. The entire contents of this Japanese Patent Application No. 2006-173293 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A fluid passage structure comprising:
a piston defining a piston chamber;
a return spring to urge the piston in a direction decreasing a volume of the piston chamber; and
a casing formed with a fluid supply passage to supply a fluid pressure into the piston chamber, the supply passage including an open end opening in the piston chamber and confronting the piston, the open end of the supply passage having an area so determined as to prevent the return spring from being deformed by kinetic energy of an operating fluid gushing into the piston chamber.

2. The fluid passage structure as claimed in claim 1, wherein the area of the open end of the supply passage is so determined as to satisfy the following relationship:
$$A \geq \sqrt{\frac{{Q}^{3} \cdot t \cdot δ}{2 K}}$$
where A is the area of the open end of the supply passage, Q is a flow rate of the operating fluid flowing into the piston chamber, t is a time during which the operating fluid flows into the piston chamber, δ is a density of the operating fluid, and K is elastic energy of the return spring.

3. The fluid passage structure as claimed in claim 2, wherein the flow rate Q is a quantity determined by a discharge quantity of a fluid pump driven by an engine and an idling speed of the engine, and the time t is a time from an empty state in which the volume of the piston chamber is minimum and substantially empty, to a full state in which the volume of the piston chamber is minimum and substantially filled with the operating fluid.

4. The fluid passage structure as claimed in claim 1, wherein the piston chamber is provided in an automatic transmission, and the fluid passage structure is a structure for the automatic transmission.

5. The fluid passage structure as claimed in claim 1, wherein the casing comprises a pump cover in which the fluid supply passage is formed and in which the piston is slidably supported.

6. An apparatus comprising:
a piston defining a piston chamber;
a return spring to urge the piston in a direction decreasing a volume of the piston chamber; and
a casing formed with a fluid supply passage to supply a fluid pressure into the piston chamber, the supply passage including an open end opening in the piston chamber and confronting the piston, the open end of the supply passage having an area so set as to hold kinetic energy of an operating fluid gushing into the piston chamber smaller than or equal to elastic energy of the return spring.

7. The apparatus as claimed in claim 6, wherein the piston includes a pressure receiving surface; the casing includes an annular flat surface confronting the pressure receiving surface of the piston; and the open end of the supply passage is opened in the annular flat surface of the casing.

8. The apparatus as claimed in claim 7, wherein the apparatus includes a transmission mechanism including a planetary gear set including a sun gear, a ring gear and a planet carrier which are arranged coaxially on a center axis, and an engaging device which is connected with one of the sun gear, the ring gear and the planet carrier of the planetary gear set, and which is arranged to be engaged by the piston when a hydraulic fluid pressure in the piston chamber is increased by supply of the operating fluid into the piston chamber, and to be disengaged by the return spring when the hydraulic fluid pressure in the piston chamber is decreased; and the open end of the supply passage is elongated circumferentially around the center axis in the annular flat surface of the casing to which the center axis is perpendicular.

9. The apparatus as claimed in claim 6, wherein the open end of the supply passage is elongated and so sized as to prevent the kinetic energy of the operating fluid gushing into the piston chamber from exceeding the elastic energy of the return spring in a state in which the volume of the piston chamber is minimum.
